(19) United States
(12) Patent Application Publication
(10) Pub. No.: US 2003/0164852 A1
(43) Pub. Date: Sep. 4, 2003

(54) Systems and methods for transferring imaging information using network-based imaging techniques

(76) Inventors: Shell Sterling Simpson, Boise, ID (US); Ward Scott Foster, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/087,553

(22) Filed: Mar. 1, 2002

(51) Int. Cl. G09G 5/00

(52) U.S. Cl. 345/748; 345/733; 345/740; 345/738

(57) ABSTRACT

Systems and methods for transferring imaging information using network-based imaging techniques are disclosed. A system may comprise a server and a computing device coupled to each other via a network. In some embodiments, a select image(s) is associated with a default composition. The default composition comprises the necessary information for a device to acquire and construct the underlying image(s). A method for transferring imaging information, can be summarized by the following steps: accessing a remote-data server, selecting image information resident on the remote-data server to generate a composition, accessing an imaging-destination service, and communicating the composition to the imaging-destination service.

### TECHNICAL FIELD

The present disclosure relates to systems and methods for processing digital representations of images. More particularly, the invention relates to systems and methods for transferring imaging information.

### BACKGROUND OF THE INVENTION

As computer technology has advanced, the role of computers in our daily lives has expanded, as has the need for communicating and/or transferring information between various computers and/or associated data-storage devices. Over the years, a host of peripheral data-processing devices have been devised and commonly used to transfer data, programs, and other information between computers (e.g. keypunch cards, paper tapes, magnetic tapes, floppy disks, read-only memory, etc.).

One significant expansion in the use of computer technology is the networking of computers. Network-coupled computers can communicate with one another as well as with other devices, such as scanners, cameras, printers, etc. As computer networks, such as the Internet, continue to develop, there is increasing demand for additional and improved functions that draw upon and exploit the full computing potential of computer networks including the ability to transfer information from one computing device to another computing device.

A common method for transferring information from one network-coupled computing device to another network-coupled computing device uses the File Transfer Protocol (FTP) that is part of the Internet's transmission-control protocol (TCP) and Internet protocol (TCP/IP) protocol suite. TCP enables two computing devices to establish a connection and exchange streams of data. TCP guarantees delivery of data and guarantees that packets will be delivered in the same order in which they were sent. IP, on the other hand, deals only with packets establishing an addressing system without the direct connection.

Technically, an FTP information transfer is not a transfer of information from one location to another, but a file copy from one computer to another. FTP may be used to transfer files across computing devices in proprietary networks, local-area networks (LANs), as well as home networks.

Copying a file from one computer to another has become a relatively common task that can be accomplished in a multitude of ways (e.g., computer to computer network transfer, computer port to computer port transfer, portable-data storage-device enabled transfer, etc.) Of the listed examples, copying files over a network is the often-preferred method.

FTP can be used to both upload and download files (including images and documents) from one computer to another. In the early 1990s, FTP was a popular way for people to upload files and download files from world-wide-web sites operative on the Internet. However, FTP in its basic form is not particularly user friendly, as its use requires a working knowledge of the FTP command structure. Not only does FTP require both an understanding and a working knowledge of its command structure, a user needs to understand and communicate both the source and the destination location for the file to be transferred. Thus, a user of FTP is required to remember sometimes long and confusing paths through complex hierarchical-data storage formats to transfer data. Consequently, for technically perceptive users, FTP is adequate, but for novice and/or unsophisticated computer users, FTP can be quite difficult.

In order to overcome some of the problems with FTP, browser providers have added the capability for a web browser to upload files (i.e., the web browser file upload mechanism). For example, most web mail applications provide a user with the ability to attach documents to a mail message. These applications generally provide a selectable icon in the form of a pushbutton on a graphical-user interface (GUI) associated with the web mail application. Upon selection of the pushbutton, the application presents a file open dialog box that allows the user to browse a local data-storage device for a file to upload to a web site. After the user selects a file, the web browser, using hypertext-transfer protocol (HTTP), will copy the file to the web site. The web site may be configured to integrate the file so that it may be selected, viewed, copied, and/or otherwise processed by other users with access authority for the web site and the file.

While this arrangement works well and is much more user friendly than FTP alone, users still need to be able to locate files within the file-management structure used by the host computer. This methodology is still problematic for those users that are unfamiliar with the file-management structure of the host computer. This unfamiliarity may arise when a guest user is operating a computing device, the user simply cannot remember where they stored a file, or when an application creates and stores data in a “default” directory, among others. Consequently, both FTP based and web browser based data transfer methods are problematic when operative on a computing device that uses a hierarchical-file system.

Despite the availability of FTP and web browser based data transfer utilities, it can be appreciated that an improved system and method that avoids one or more of the problems noted above for transferring data between network-coupled computing devices is desired.

### SUMMARY OF THE INVENTION

In response to these and other shortcomings of the prior art, systems and methods for posting-imaging information to a network-connected computing device have been invented and are disclosed.

In some embodiments, a network-coupled imaging-service operative on a server offers a mechanism for processing and/or storing photographs. The photographs may be stored on various devices coupled to the network. An imaging-client computing device can be used to identify one or more photographs for inclusion in an image composition for subsequent uses.

In other exemplar embodiments, an image composition may include a text document, a letterhead (e.g., a graphic design), a watermark (e.g. a graphic design identifying the source of the document), and in some arrangements a label indicating the status of a working document still in process (e.g., a “draft”). In these embodiments, the system can be used to archive documents in the condition they were in on a specific date by storing a composition of the various images that together form a document of interest.

Some embodiments of the system can be viewed as providing methods for transferring information using network-based imaging solutions. In this regard, a method can be summarized by the following steps: accessing a remote-data server, selecting image information resident on the remote-data server to generate a composition, accessing an imaging-destination service, and communicating the composition to the imaging-destination service. A method for adding imaging information to a service is also disclosed. The method is summarized by the following steps: receiving a composition, identifying the location of the component images comprising the composition, copying the identified component images of the composition, and storing the component images.

Other systems, methods, and features associated with posting and/or transferring imaging information will become apparent to one with skill in the art upon examination of the following drawings and detailed description. It is intended that all such additional systems, methods, and features included within this description, are within the scope of the systems and methods for transferring imaging information as protected by the accompanying claims.

### BRIEF DESCRIPTION OF THE DRAWINGS

The systems and methods for posting imaging information can be better understood with reference to the following drawings. The components in the drawings are not necessarily to scale. Emphasis instead is placed upon clearly illustrating the principles of transferring imaging information to a remote-computing device. Furthermore, in the drawings, like reference numerals designate corresponding parts throughout the several views.

FIG. 1 is a schematic illustrating the general operation of an exemplar solution for posting imaging information.

FIG. 2 is a schematic diagram illustrating an embodiment of a distributed system in which the system and method for posting imaging information of FIG. 1 may be realized.

FIG. 3 is a first example of an embodiment of a network-based imaging system in which the system and method for posting imaging information of FIG. 1 may be realized.

FIG. 4 is an alternative embodiment of a network-based imaging system in which the system and method for posting imaging information of FIG. 1.

FIG. 5 is a schematic of an embodiment of the imaging-client device shown in FIGS. 3 and 4.

FIG. 6 is a flowchart illustrating a method for posting imaging information that may be used in the network-based imaging system of FIGS. 3 and 4.

FIG. 7 is a schematic diagram illustrating an embodiment of an exemplar network-based imaging solution that illustrates data flow where the imaging source and imaging destinations process images of photographs.

FIG. 8 is a schematic diagram illustrating an embodiment of an exemplar network-based imaging solution that illustrates data flow where the imaging source and the imaging destinations process images of documents.

FIG. 9 is a flowchart illustrating a method for archiving image-based compositions with a network-connected data-storage device that may be realized in the network-based imaging system of FIG. 6.

### DETAILED DESCRIPTION

Various aspects of the system and method for transferring information using network-based imaging solutions, having been summarized above, reference will now be made in detail to the description of the exemplar systems and methods illustrated in the drawings. While the systems and methods for transferring information will be described in connection with these drawings, there is no intent to limit it to the embodiment or embodiments disclosed therein. On the contrary, the intent is to cover all alternatives, modifications, and equivalents included within the scope of the systems and methods for transferring information using network-based imaging solutions as defined by the appended claims.

Generally, the system has a distributed architecture with which a user can maintain data in a personal-imaging repository. Various network-coupled services, including services that generate and store and/or simply store collections of text and graphic images, among other services, may controllably provide data to, or alternatively accept data from, one or more users to compose and/or select an image composition. An image composition includes that information necessary to formulate a representation of the underlying photographs, documents, and/or other information contained in the image(s).

Default compositions or simply “compositions” contain information, such as the contents of a letter or other correspondence that a user of the system desires to integrate to form a product. Alternatively, a default composition may contain the necessary information to identify one or more images, such as photographs processed and stored on a data-storage device coupled to a networked computer. In some arrangements, the various components of a letter formed by a number of images may be stored in a user's personal-imaging repository. The individual images may be referenced by a composition that provides access to one or more services interested in using the images (e.g., photographs, documents, etc.) identified by the composition.

A destination service in the system accesses imaging information available through a user's personal-imaging repository. Conversely, a source service in the system contributes information to a user's personal-imaging repository. This imaging information can be accessed and/or provided in a variety of forms because the imaging information is accessed through a collection of methods (i.e., a programmatic interface) that enables a node in the system (i.e., a personal-imaging repository, a destination service, a source service, and/or a service that acts as both a destination and a source service, among others) to negotiate the preferred form(s) in which it wishes to transfer data. A system node can be a computing device or some other device, such as a router, a printer, a scanner, among others, communicatively coupled with the network. Each node has a unique network address sometimes called a data-link control (DLC) address or a media-access control (MAC) address.

In preferred arrangements, the user identifies and accesses a network-based or web-based imaging service that enables the user to access the imaging data in the user's personal-imaging repository (i.e., a target image file), as well as arrange the imaging data as desired. An imaging-source service does not necessarily have to access a personal-imaging repository before contributing imaging information (including the arrangement of imaging information, which, in a sense, is just another kind of imaging information) to the user's personal-imaging repository. An imaging-source service generates imaging data that is added to the user's personal-imaging repository. This can be accomplished by the user inputting data, the user arranging existing data already in their personal-imaging repository, as well as by other methods. Thus “imaging data” is associated with the user in question, so that imaging-destination services can subsequently use user-specific data. Thereafter, as desired, a network-based imaging server can be accessed to formulate and/or retrieve a desired composition for integration with one or more images stored in the user's personal-imaging repository or within an imaging-client device.

The imaging service may be realized on a local node (i.e., a local-area network-connected device) or a remote node (i.e., a wide-area network-connected device) in the system. In some embodiments, the imaging service may be integrated with a print service or other publishing service such as a photograph developer. As in the case of the imaging service, the photo-developing service may also be realized on local node or a remote node in the system. In other alternative embodiments, an imaging service may be embedded within a print device, an image-acquisition device, such as a digital camera, a digital-video camera, a scanner, among others, or may operate on a server separate and distinct from the print device. It should be appreciated that in the case where the image service is remotely located, the user may be interfacing with a third-party operated service that may provide network-based services in exchange for payment of a fee. For example, the photo developer may develop prints from exposed photographic film, scan the prints, and post the scanned prints on a web site for later distribution by the owner of the photographic film.

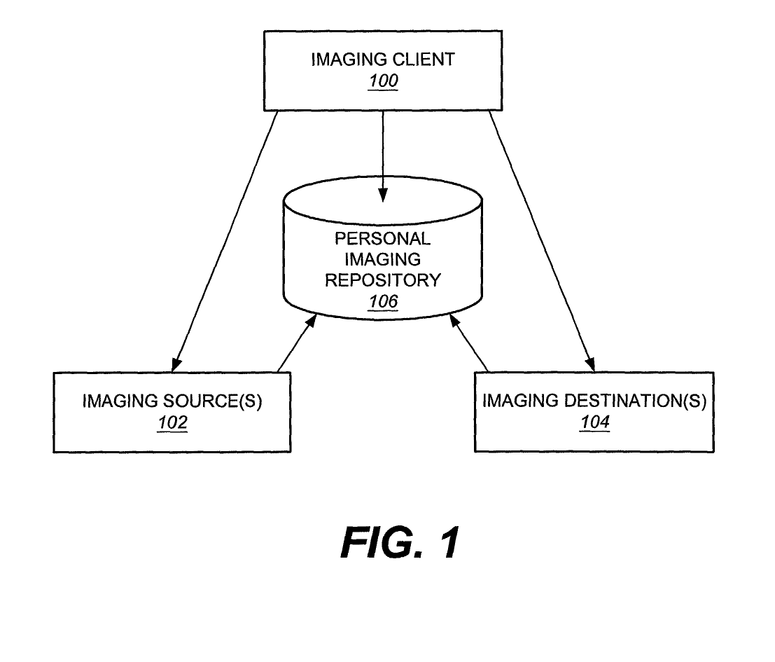

FIG. 1 is a schematic representation of the general operation of the systems and methods for transferring image information. As shown in this figure, an imaging client 100 communicates with one or more imaging sources 102, one or more imaging destinations 104, and a personal-imaging repository 106. The imaging source(s) 102 represent any of a variety of devices/services that can be accessed by the imaging client 100 and used to select or identify imaging data that may be integrated with a previously stored target image (e.g., a text document, a photo, or other images).

The personal-imaging repository 106 provides image storage facilities that typically are personalized for the individual imaging client 100. The imaging repository 106 can be located in various places. For example, the repository 106 can be maintained on one or more computing devices associated with the imaging client 100, imaging source(s) 102, or imaging destination(s) 104. Alternatively, the repository 106 can be maintained on a separate computing device (e.g., a file server) that the imaging client 100, imaging source(s) 102, and imaging destination(s) 104 can access. The data in the imaging repository 106 can be any type of image or graphics-based data, such as text images, video frames, animations, photographs, and/or combinations thereof.

Once data is stored in the personal-imaging repository 106, the imaging client 100 can select data from the repository that is intended to be communicated to the imaging destination(s) 104 for some form of processing or manipulation. By way of example, the data may be transmitted to the image destination(s) 104 for printing and/or displaying or distributing an image of a photograph. In preferred embodiments, the data may include a composition or a set of identifiers identifying both a composition and one or more target images. Where the imaging destination(s) 104 are adapted for printing, they may comprise any of a wide variety of printing devices that are capable of generating hard-copy products, such as printers, multi-function peripherals (MFPs), plotters, services-managing printing devices, and others.

As will be apparent from the discussions that follow, the above-described manner of operation provides a high degree of personalization to the imaging client 100. Specifically, in that the client's personal information can be accessed and utilized with any participating service (e.g., web site) accessible by the client, each accessible service can be “customized” based on the underlying data for each particular user.

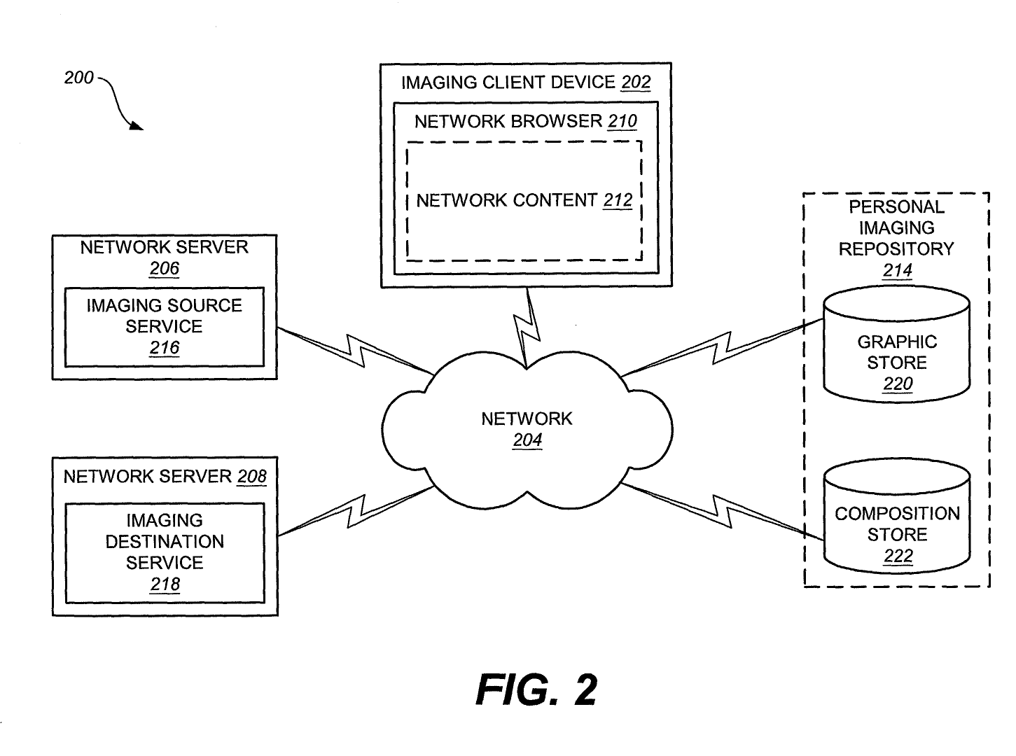

FIG. 2 illustrates an exemplar-distributed system 200 in which the systems and methods for transferring imaging information can be implemented. As indicated in FIG. 2, the system 200 includes an imaging-client device 202 that is coupled to a network 204. Through this coupling, the imaging-client device 202, and therefore the imaging client (i.e., a user), can be placed in communication with one or more network servers, such as servers 206 and 208. The imaging-client device 202 and network servers 206 and 208 represent any of a wide variety of wired and/or wireless computing devices, such as desktop computers, portable computers, dedicated server computers, multi-processor computing devices, personal-digital assistants (PDAs), mobile telephones, pen-based computers, gaming consoles, and so forth.

The network 204 represents one or more data distribution networks that can be used to communicate data and other information (e.g., control information) between or among various computing devices. Examples for the network 204 include the publicly accessible wide-area network (WAN) commonly known as the Internet, a local-area network (LAN), other public and/or private WANs, and combinations thereof. The network 204 can further include various different types of networks, including wired and/or wireless portions, employing any of a variety of different communications protocols including public and/or proprietary communications protocols.

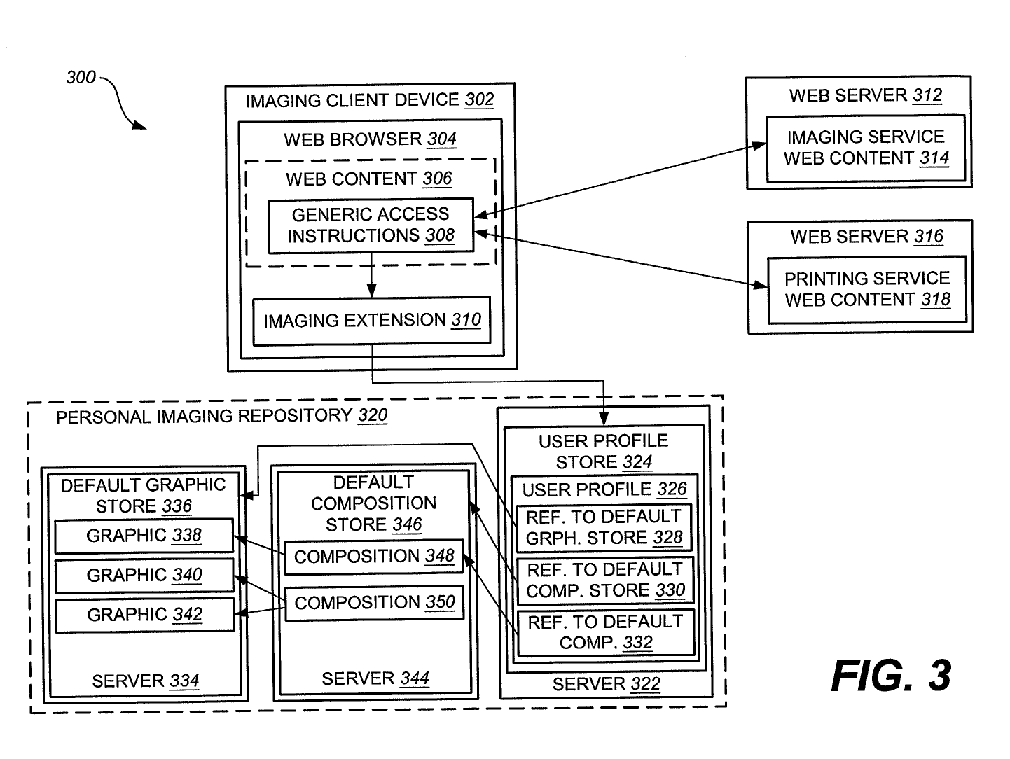

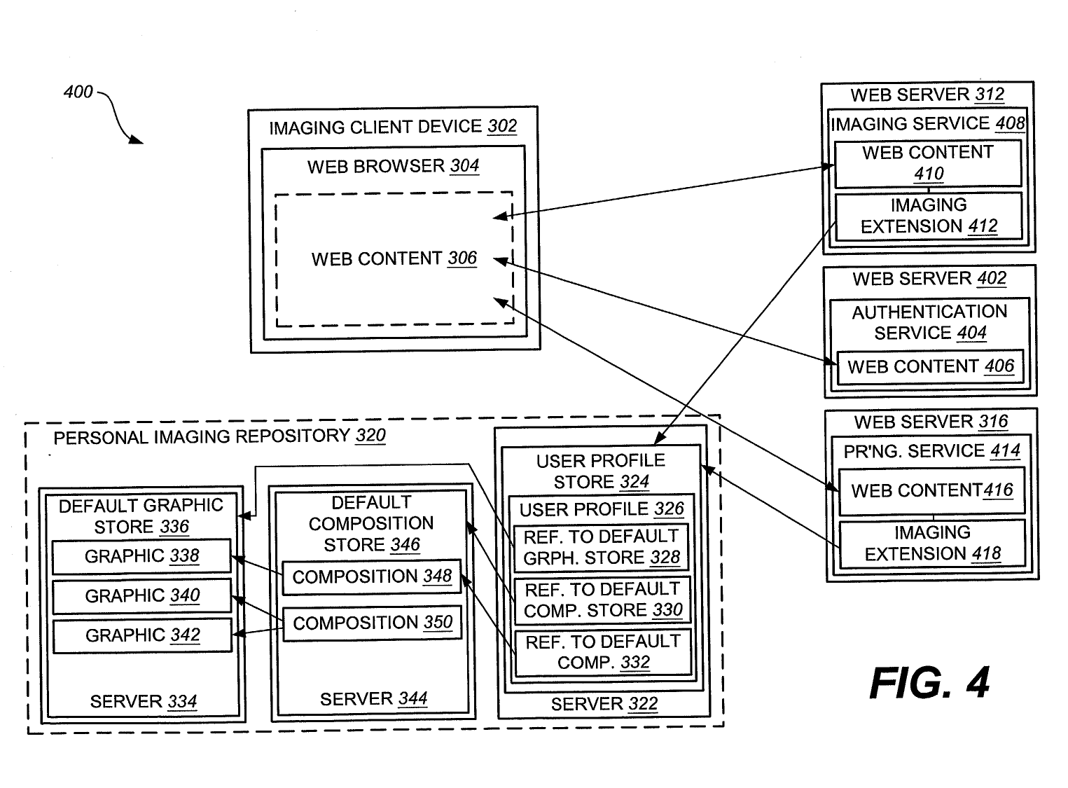

During operation, the user can operate a network browser 210 executing on the imaging-client device 202 to interact with imaging services 216, 218 executing on the network servers 206 and 208, respectively. As used herein, the term “services” refers to software and/or firmware components that can execute on one or more computing devices and which provide one or more particular functions to the imaging-client device 202, such as imaging-data selection and arrangement, data manipulation (including integration of a composition), printing, and others. As indicated in FIG. 2, the network browser 210 can receive network content 212 from one or more of the network servers 206 and 208. This content 212 may include various components such as, for example, text, graphics, commands (e.g., hypertext mark-up language (HTML), Java™, JavaScript™, etc.) and/or applications (e.g., Java™ applets). In use, the content 212 in some arrangements may facilitate communication with a personal-imaging repository 214 so that the servers 206 and 208 can access data stored in the personal-imaging repository 214. Examples of the ways in which this communication can be facilitated are described below with reference to FIGS. 3 and 4.

The network server 206 executes an imaging-source service 216 that, among other things, allows the user to interact with his or her personal-imaging repository 214. The imaging-source service 216 may actually provide multiple services that can be accessed by the user. In some embodiments, these services can provide different functions to the user. For instance, one service may be responsible for graphic storage and retrieval, while another service may be responsible for merging graphics in a single document. By accessing these services with the network browser 210, the user can select or identify imaging data that are to be stored as graphics in a graphic store 220 of the personal-imaging repository 214. These graphics can be stored as individual files and generally can comprise any data capable of representation as a two-dimensional graphic. As discussed below, the individual graphics in store 220 can be used as individual images that can be printed or otherwise reproduced on appropriate media, or multiple individual graphics can be compiled together as a single image for printing and/or other methods of generating a hard-copy output.

Irrespective of whether multiple graphics are to be used, the imaging-source service 216 can be used to arrange the graphic(s) on a visual representation of a document to be created. Once the arrangement has been selected, the imaging-source service 216 can store the arrangement as a composition (i.e., a collection of images) in a composition store 222 of the personal-image repository 214. It is to be noted that, although the graphic store 220 and the composition store 222 are illustrated as two separate stores, multiple stores may exist in the system 200 and one or more graphic stores 220 may be combined with one or more composition stores 222 as desired. Additionally, one or more of these stores 220 and 222 may be implemented on the imaging-client device 202, one or more of the servers 206 or 208, or on other designated computing devices (not shown).

Once the graphics and composition have been selected, the image data can be processed or otherwise manipulated by accessing an imaging-destination service 218 that executes on the network server 208. Where one or more hard-copy products are to be generated, this service 218 can comprise a print service with which document(s) can be printed and/or other hard-copy products may be generated. In one such scenario, a print request is communicated to the imaging-destination service 218 and, upon receipt of the print request, the network server 208 interacts with the graphic store 220 and composition store 222 to retrieve the data needed to complete the print job. Once the data are retrieved, the network server 208 interacts with one or more printing devices (not shown) to which the server is coupled (directly or indirectly) to generate the hard-copy document(s).

FIG. 3 illustrates a first exemplar network-based imaging system 300 in which the systems and methods for transferring imaging information can be implemented. As will be appreciated from the discussion that follows, this system 300 can be described as a client-based implementation in that much of the system functionality is provided by a client device. A similar system is described in detail in U.S. patent application Ser. No. ______, entitled “A Method, System and Program Product for Multi-Profile Operations and Expansive Profile Operation,” by Shell Simpson, Ward Foster, and Kris Livingston and bearing Attorney Docket No. 10007690-1, the disclosure of which is hereby incorporated by reference in its entirety into the present disclosure.

As indicated in FIG. 3, the system 300 includes an imaging-client device 302. The imaging-client device 302 comprises a web browser 304 that is adapted to access web content 306 derived from imaging-service web content 314 and printing-service web content 318 of web servers 312 and 316, respectively. The web content 306, like content 212, typically comprises text, graphics, and various commands. The commands can comprise one or more sets of executable instructions that are downloaded (i.e., communicated) to the web browser 304 to perform a service requested by the user. These instructions can be written in any suitable language including, for instance, HTML, Java™, JavaScript™, C-sharp, or other appropriate languages. A variety of different functions can be served by the executable instructions. For example, the web content 306 normally includes executable instructions for causing graphics, i.e. graphics provided by an accessed web site, such as, but not limited to a composition, to be displayed on an input/output device, such as a display monitor in association with the imaging-client device 302.

In the embodiment shown in FIG. 3, the executable instructions are further used to access a personal-imaging repository 320. These instructions typically comprise system-wide generic access instructions 308 that call on an imaging extension 310 to access the personal-imaging repository 320 and perform various web-imaging operations. These instructions 308 are designated as “generic” because they are independent of the configuration of the user's personal-imaging repository 320. As discussed in greater detail below, the generic-access instructions 308 can be used to, for example, add a graphic, such as a composition, to a default-graphic store 336 of the personal-imaging repository 320, or add a new composition to a default-composition store 346 of the personal-imaging repository 320.

As is further indicated in FIG. 3, the imaging extension 310 can form part of the web browser 304. Although this arrangement is shown in the figure and described herein, the imaging extension 310 can, alternatively, be provided outside of the web browser 304, for instance on a different device. Irrespective of its location, however, the imaging extension 310 is configured to respond to the execution of the generic access instructions 308 by generating and/or mapping corresponding imaging client specific commands entered by the user. The imaging extension 310 typically is implemented as one or more application-programming instructions (APIs) that, preferably, act as interfaces in accordance with a system-wide standard.

When executed, the generic-access instructions 308 cause imaging-extension calls (e.g., API calls) to be issued, which in turn, cause the imaging extension 310 (e.g., APIs) to access the user's personal-imaging repository 320. The web content 306 therefore uses the imaging extension 310 as a gateway to access the user's personal-imaging repository 320. Generally, the APIs can comprise sets of methods for establishing a destination for redirecting the web browser 304 based on some form of received redirection initiation. In such circumstances, the process normally comprises receiving a redirection initiation to redirect the web browser 304, retrieving a direct or indirect reference to a destination, and then causing the web browser 304 to extract information from that particular destination. It will be recognized that there are many other ways (both in hardware and software) to implement this function.

In some arrangements, the imaging extension 310 is configured to prevent the web content 306 (i.e., the executable instructions from one or more web services), from arbitrarily accessing the user's personal-imaging repository 320. This restricted access can be imposed upon the web content 306 using a variety of methods. For example, an imaging extension API can be configured to only accept references from the web content 306 that were previously provided by the imaging extension 310. In such a scenario, the content 306 cannot arbitrarily supply references when calling the imaging extension API. Therefore, to access the user's personal-imaging repository 320, the web content 306 must first obtain references using the imaging extension API.

The imaging extension 310 can be used to access one or more user profiles 326 that is/are stored in a user-profile store 324 of a server 322 of the personal-imaging repository 320. By way of example, the imaging extension 310 can be directed to the user profile 326 with a uniform-resource locator (URL), pointer, socket, or other detail. In some embodiments, the same user can have multiple user profiles. This may be particularly advantageous when a firewall (not shown) is encountered. When firewalls are encountered, different graphic stores and composition stores can be accessed depending on the location of the firewall in relation to the various stores and a communicating node.

The user profile 326 typically includes references to all or a portion of the personal-imaging repository 320 for that user profile. For instance, as shown in FIG. 3, the user profile 326 can include a reference 328 to a default-graphic store, a reference 330 to a default-composition store, and a reference 332 to a default composition. In use, the user-profile store 324 functions as a service that uses appropriate methods to create, modify, access, and cancel profiles. Accordingly, the imaging extension 310 maps to the appropriate methods (i.e., makes use of the methods) in the user profile 326 to obtain the reference to various repository items such as the default-graphic store 336 and the default-composition store 346.

Like the user-profile store 324, the default-graphic store 336 and default-composition store 346 can reside on separate servers 334 and 344. It will be understood, however, that one or more of the stores could reside on a single machine, if desired. As indicated in FIG. 3, the default-graphic store 336 is used to store various graphics, such as graphics 338, 340, and 342. These graphics can be stored in substantially any format. For example, these formats (i.e., file extensions) can comprise PDF, JPEG, PostScript, TIFF, GIF, BMP, etc. In addition, the default graphic store 336 can include a programming interface consisting of a number of methods. Because the default-graphic store 336 is implemented as a network service, these methods would be accessible through some sort of remote-invocation technology such as a remote-procedure call (RPC), a simple object-access protocol (SOAP), a common-object request-broker architecture (CORBA), a distributed-component object model (DCOM), or others. Therefore, in contrast to merely providing for graphic storage, the graphic store 336 can also provide services used to create, retrieve, and/or manipulate graphics. These services may include a user interface for integrating various images as compositions with target images stored within the graphics store 336. Furthermore, the default-graphic store 336 can communicate with the web content of various web services. For example, printing-service web content 318 can submit queries to the default-graphic store 336 (via the extension 310) about a print job, as well as request that one or more graphics be transmitted in a desired arrangement to optimize printing performance. In some circumstances, the request may include a request for a composition (i.e., a collection of images) as well as a target image.

The default-composition store 346 stores various compositions, such as compositions, 348 and 350, which can be used to arrange the selected graphics. Like the user-profile store 324 and default-graphic store 336, the default-composition store 346 can also comprise various programming interfaces consisting of a number of methods that can be used to access graphics from the graphic store, manipulate the graphics, etc.

FIG. 4 illustrates a second exemplar network-based imaging system 400 in which the systems and methods for transferring imaging information can be realized. As indicated in FIG. 4, the system 400 includes many of the features of the system 300 shown in FIG. 3. Therefore, the system 400 includes an imaging-client device 302 that executes a web browser 304 to receive web content 306. The system 400 also includes a personal-imaging repository 320 that for example, can include a user-profile store 324, a default-graphic store 336, and a default-composition store 346. Furthermore, the system 400 includes web servers 312 and 316. Each of these components is generally configured in a similar manner as the like-named and numbered features identified in FIG. 3. However, unlike the client-based system 300, the system 400 provides a server-based implementation in which many of the functions provided by the client device 302 in the system 300 are transferred to another device. By way of example, this other device can comprise an additional web server 402, which executes an authentication service 404. As shown in FIG. 4, the authentication service 404 comprises web content 406 that can be downloaded into the user's browser 304.

In addition to the above-noted differences, the servers 312 and 316 are provided with different software in the system 400 to permit alternative modes of operation. By way of example, the web server 312 can execute an imaging service 408, which includes web content 410 and an imaging extension 412. Similarly, the web server 316 can execute a printing service 414 that includes web content 416 and an imaging extension 418. Like the web content 314 and 318 of the system 300, the web content 410 and web content 416 typically comprise text and graphics that can be downloaded into the user's browser 304. Unlike the system 300, however, generic-access instructions need not be downloaded into the browser 304 in that the browser does not comprise its own imaging extension. Such an arrangement is advantageous where the imaging-client device 302 has limited storage capacity (e.g., for PDAs, mobile telephones, and other similar devices). Instead, as identified above, the services 408 and 414 include their own imaging extensions 412 and 418, respectively, that can be used to access the user's personal-imaging repository 320. By way of example, the web content 410 and 416 comprise server-side code including one or more of personal-home page (PHP) or personal-home page hypertext-preprocessor scripts, Java™ Servlets, Java™ server pages (JSPs), active-server pages (ASPs), etc.

Each of the imaging extensions 412 and 418 typically has configurations that are similar to that of the imaging extension 310 (FIG. 3). Therefore, the imaging extensions 412 and 418 can comprise one or more programmatic interfaces that include one or more methods that, when invoked, access the user's personal-imaging repository 320. Again, the programmatic interfaces can comprise sets of methods for establishing a destination for redirecting the browser 304 based on some form of received redirection initiation. The programmatic interface can include methods that return or make use of, for instance, a URL, pointer, socket, or other detail to facilitate the redirection.

The manner in which the personal-imaging repository 320 is accessed by the services in the system 400 will now be discussed with reference to an exemplar scenario. In this example, the user browses to the imaging service 408 using the web browser 304 of the imaging-client device 302. Upon reaching the service 408, web content 410 is executed to generate web pages that are downloaded to the web browser 304 (as content 306).

For the purposes of this application, a web page refers both to data that is executed within the web server to generate data to be downloaded to the browser, as well as data that is downloaded to and executes within the browser. Presently, the art fails to distinguish between different stages of web-page generation. The terms “server-side” and “client-side,” however, are often used to distinguish where web page related execution occurs. Once the content 306 is received, the browser 304 is redirected by the content 306 to the authentication service 404 that resides on the web server 402. Typically, this is accomplished by the web content 410 through the creation of a hypertext-transfer protocol (HTTP) redirect that when downloaded to the browser 304, causes the browser to redirect to an address (e.g., URL) identified in the header entry. Web content 410 is then downloaded to the web browser 304 and the user is provided with an opportunity to complete an authentication procedure that identifies both the user's identity and the location of the user's personal-imaging repository 320.

The authentication procedure can, for example, comprise entry of authentication information, such as a user name and password that have been registered with the authentication service 404, for example, in a previous session. This information can be entered in a web page generated by the web server 402. In an alternative arrangement, the authentication procedure can comprise the reading of a user-identification card, which includes storage media (e.g., magnetic strip) that contains the user's authentication information. Persons having ordinary skill in the art will recognize that many other authentication alternatives exist that may be integrated with the systems and methods for integrating virtual letterhead(s).

Once the user successfully completes the authentication procedure, the browser 304 is again redirected, this time back to the imaging service 408. The redirection address (e.g., URL) directs the web browser 304 back to the imaging service 408 and may contain information that identifies the user and the user's personal-imaging repository 320 (e.g., with a further URL). To avoid continual redirection back and forth, a “cookie” can be stored on the imaging-client device 302 that permits the authentication service 404 to validate the user's identity without requiring a further log in. Note that the use of a “cookie” by the authentication service does not eliminate redirection between the imaging service and an authentication service. Such a “cookie” merely eliminates the need to query the user for identification information. A “cookie” could be used by the imaging service to avoid redirection to the authentication services. Once the user's identity information is possessed by the imaging service 408, the service can, when appropriate, make calls to its imaging extension 412 (e.g., programmatic-interface calls) to command the imaging extension to access the user-profile store 324 of the personal-imaging repository 320. Through this access, the imaging service 408 can be used by the user to, for instance, select or identify imaging data to be stored as graphics in the default-graphic store 336.

When the printing service 414 is accessed, for example through redirection from the imaging service 408, as when a “print” button is selected, various content is downloaded to the web browser 304. The printing service 414 can then access the default-graphic store 336 and default-composition store 346 such that the graphics to be printed can be accessed and an intended arrangement of the document obtained. Although the default-graphic store 336 and default-composition store 346 may be accessed, typically a destination service such as printing service 414 accesses the default composition from the user profile. The default composition determines which graphics are accessed. The default composition may or may not refer to a composition that is located in the default-composition store 346.

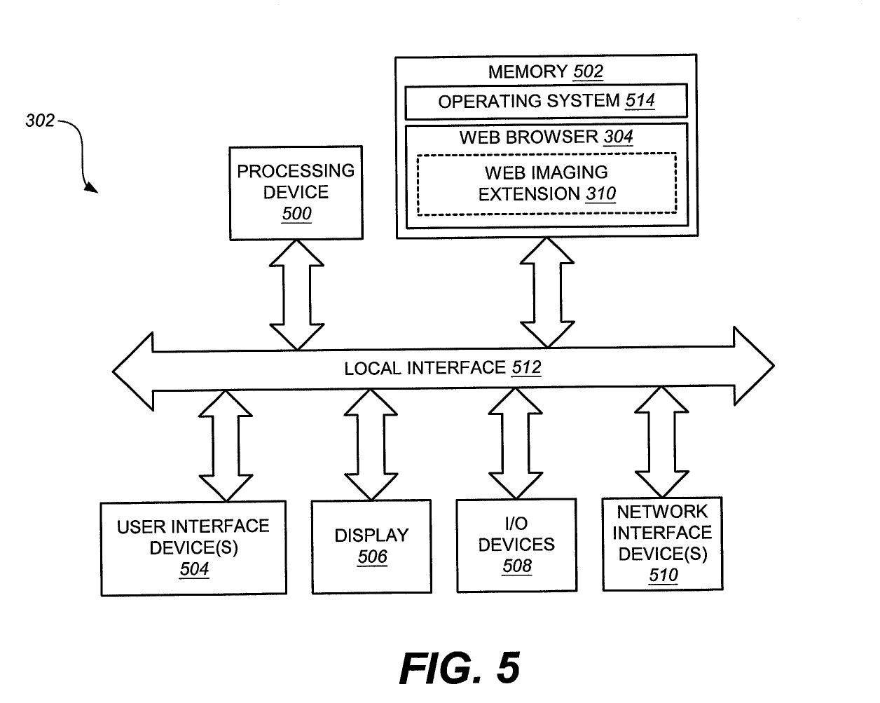

Reference is now directed to FIG. 5, which presents a schematic view illustrating an exemplar architecture of the imaging-client device 302 introduced in FIGS. 3 and 4. As identified above, the client device 302 can be any one of a variety of computing devices, such as desktop computers, portable computers, dedicated server computers, multi-processor computing devices, cellular telephones, PDAs, handheld or pen-based computers, gaming consoles, and others. Irrespective of its type, the client device 302 typically comprises a processing device 500, memory 502, one or more user-interface devices 504, a display 506, one or more input/output (I/O) devices 508, and one or more network-interface devices 510, each of which is connected to a local interface 512.

The local interface 512 can be, but is not limited to, one or more buses or other wired or wireless connections as is known in the art. The local interface 512 may have additional elements, such as buffers (caches), drivers, and controllers (omitted here for simplicity), to enable communications. Further, the local interface 512 includes address, control, and data connections to enable appropriate communications among the aforementioned components.

The processing device 500 can include any custom made or commercially available processor, a central processing unit (CPU) or an auxiliary processor among several processors associated with the client device 302, a semiconductor-based microprocessor (in the form of a microchip), a macro-processor, one or more application-specific integrated circuits (ASICs), a plurality of suitably configured digital-logic gates, and other well known electrical configurations comprising discrete elements both individually and in various combinations to coordinate the overall operation of the imaging-client device 302. The memory 502 can include any one of a combination of volatile-memory elements (e.g., random-access memory (RAM, such as DRAM, SRAM, etc.)) and nonvolatile-memory elements (e.g. ROM, hard drive, tape, CD-ROM, etc.).

The one or more user-interface devices 504 comprise those components with which the user can interact with the imaging-client device 302. For example, where the imaging-client device 302 comprises a personal computer (PC), these components can comprise a keyboard, a mouse, a joystick, etc. Where the imaging-client device 302 comprises a handheld device (e.g., PDA, mobile telephone), these components can comprise function keys or buttons, a touch-sensitive screen, a stylus, etc. The display 506 can comprise a computer monitor or plasma screen for a PC or a liquid crystal display (LCD) for a handheld device.

With further reference to FIG. 5, the one or more I/O devices 508 are adapted to facilitate connection of the client device 302 to another device and may therefore include one or more serial, parallel, small computer-system interface (SCSI), universal-serial bus (USB), IEEE 1394 (e.g., Firewire™), and/or personal-area network (PAN) components. The network-interface devices 510 comprise the various components used to transmit and/or receive data over a network (e.g., network 204 in FIG. 2). By way of example, the network-interface devices 510 include a device that can communicate both inputs and outputs, for instance, a modulator/demodulator (e.g., modem), a wireless (e.g., radio frequency (RF)) transceiver, a telephonic interface, a bridge, a router, a network card, etc.

The memory 502 generally comprises an operating system 514 and a web browser 304. The operating system 514 controls the execution of other software and provides scheduling, input-output control, file and data management, memory management, and communication control and related services. As noted above with reference to FIGS. 3 and 4, the web browser 304 comprises software and/or firmware that is used to access various services over a network (e.g., Internet) and, therefore, download content from various different sources (e.g., imaging-service web content 314, printing-service web content 318, web content 406, 410, and 416, etc.). Where the web browser 304 is configured as indicated in FIG. 3, the web browser 304 can comprise an imaging extension 310. However, it will be understood that where the system is arranged as indicated in FIG. 4, the imaging extension 310 need not be provided in the web browser 304.

The architecture of the various servers shown in FIGS. 3 and 4 are typically similar to that described above with reference to FIG. 5. Therefore, separate figures are not provided for these servers. However, persons having ordinary skill in the art will recognize that various architectures could be used to realize the servers.

The various software and/or firmware described above can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction-execution system, apparatus, or device, such as a computer-based system, processor-containing system, or other system that can fetch the instructions from the instruction-execution system, apparatus, or device and execute the instructions. In the context of this document, a “computer-readable medium” can be any means that can store, communicate, propagate, or transport the program for use by or in connection with the instruction-execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable-computer diskette, a random-access memory (RAM), a read-only memory (ROM), an erasable-programmable read-only memory (EPROM, EEPROM, or Flash memory), an optical fiber, and a portable compact-disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

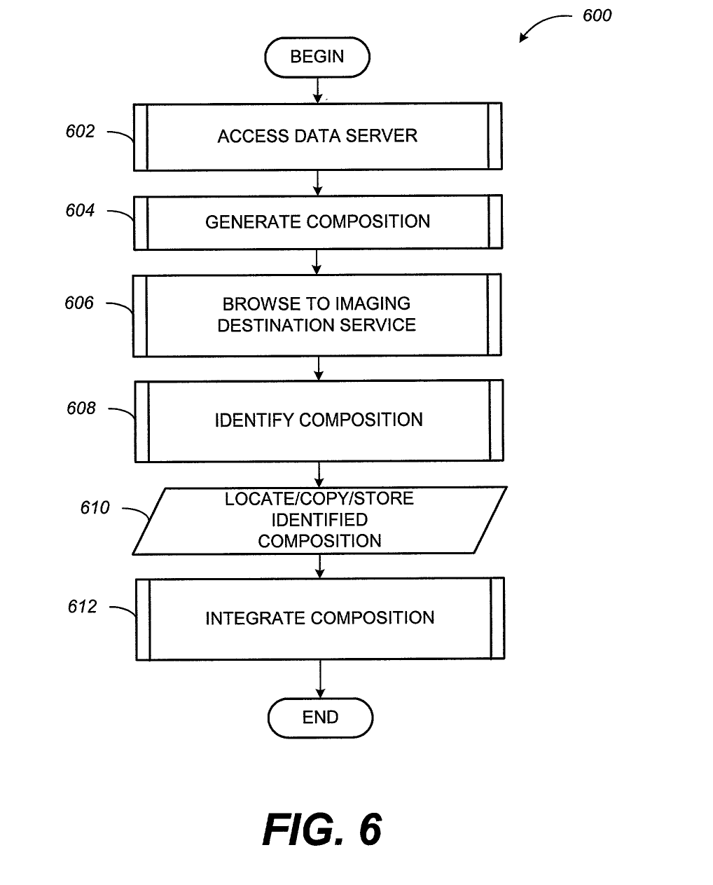

FIG. 6 is a flow diagram illustrating an exemplar method for transferring imaging information that may be performed by the network-based imaging systems 300, 400 illustrated in FIGS. 3 and 4, respectively. As illustrated in FIG. 6, the method 600 may begin with step 602 where a computing device coupled to the systems 300, 400 accesses a data server. As described above, the data server may contain software code that provides an imaging-source service 216 (FIG. 2) to users with authority to access the software code. The imaging-source service 216 may include a photograph processing and distribution web site designed to process images scanned from prints made from traditional film-based photographic equipment as well as enhanced images from digital sources. Alternatively, the accessed imaging-source service 216 may include a document publishing and archiving system designed to assemble both hard copy products and digital renditions of documents formed by image components.

As illustrated in step 604, the computing device may be programmed to generate a composition. The composition may contain information identifying a particular user's photographs in the photograph processing and distribution web site. In the case where the imaging-destination service 218 (FIG. 2) is a document publishing and archiving system, the composition contains that information necessary to identify the components of the finished document. For example, a document may include a letterhead, a body, a watermark, a signature block and/or a digital signature or certificate, as well as a status label, among other component parts.

Once the user has generated the composition, the user operating a web browser 304 (FIG. 3) or other suitable application code on a computing device coupled to the network system 300, 400 may browse or otherwise communicate with an imaging-destination service 218 (FIG. 2) as illustrated in step 606. The imaging-destination service 218 may be a family web site, a school web site, an alumni web site, among others designated for receiving one or more photographs previously processed and stored by the imaging-source service 216. In the case where the composition is designated for a document publishing and archiving system, the imaging-destination service 218 may include a combination of software and data-storage devices for archiving correspondence generated by the user of the computing device.

Once the user has established a communication link or session with the imaging-destination service 218 (FIG. 2), the computing device may be programmed to prompt the user to identify the composition that the user wishes to “deliver” to the imaging-destination service 218 as indicated in step 608. Alternatively, the identification of the composition may be accomplished by inspecting the value of the default composition (a reference to some composition) and automatically using the referenced composition as the composition the user wished to deliver. It should be appreciated that the communication link or session with the imaging-destination service 218 may take many different forms based on the type of imaging service, available functions provided by the service, among other factors.

Next, as illustrated in step 610, the imaging-destination service 218 (FIG. 2) may be programmed to use information contained within the composition to locate, copy, and store the component images identified by the composition. As described above, the imaging-destination service computing device may be coupled to one or more data-storage devices directly or alternatively, the computing device may be programmed to forward the information to one or more data-storage devices coupled to the network at remote locations. It is important to note that an imaging-destination service 218 need not copy and store each of the underlying images (although it may operate in that manner) identified in the composition. The imaging-destination service 218, when provided a composition can use the information contained within the composition to identify the storage locations, as well as other information that permits the imaging-destination service 218 to access the components as required.

The imaging-destination service 218 (FIG. 2) having located, copied, and stored the identified composition in step 610 may then be programmed to integrate the composition into various data structures within the imaging-destination service 218 as indicated in step 612. These structures may include client data, composition data, and other information necessary to operate the underlying service.

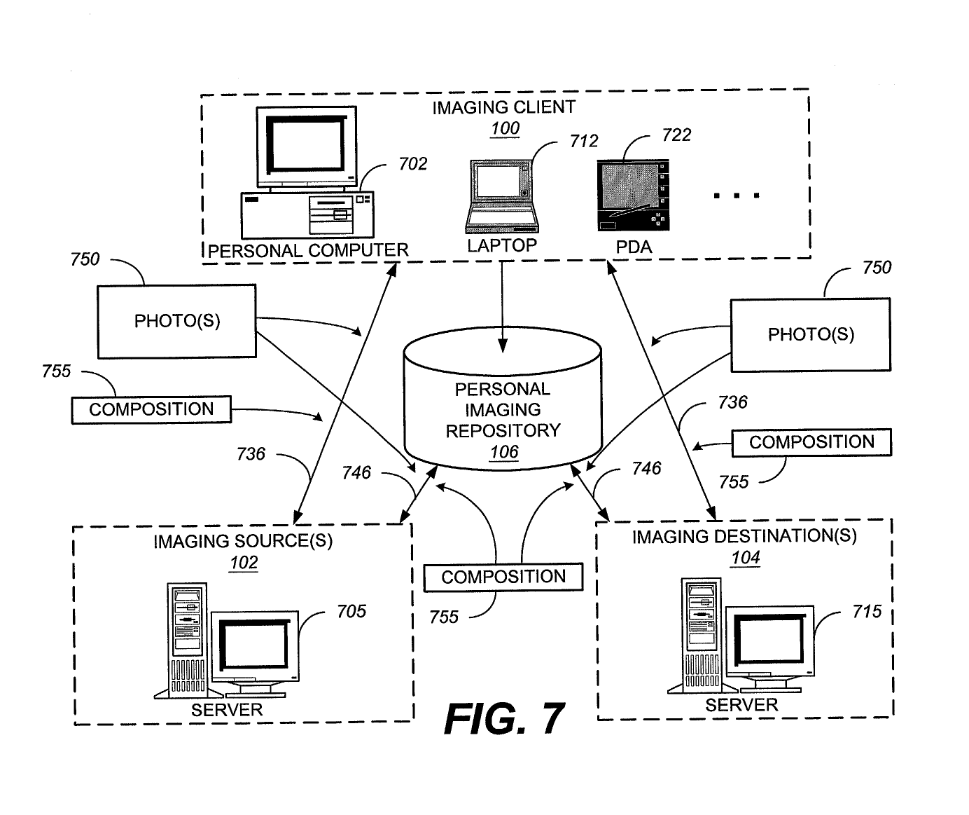

FIG. 7 is a schematic diagram illustrating an exemplar network-based imaging solution that illustrates data flows between the various computing devices and a user's personal-imaging repository 106 where the imaging source(s) 102 and imaging destination(s) 104 process images of photographs 750. As illustrated in the figure, an imaging client 100 communicates with one or more imaging sources 102, one or more imaging destinations 104, and possibly a personal-imaging repository 106. In this particular arrangement, the imaging source(s) 102 is a photograph processing and distribution service represented by server 705. As described above, the server 705 may contain one or more images of photographs belonging to an operator of one or more of the imaging-client computing devices 702, 712, 722, among others. The imaging destination 104, as illustrated in the schematic of FIG. 7 is a family web site operative on server 715. It will be appreciated that a family web site, as well as other types of web sites suitable for posting images may be operated by a third party, such as an Internet access provider.

The personal-imaging repository 106 provides image storage facilities that may be personalized for each of the operators of the imaging-client computing devices 702, 712, 722, etc. As also described above, the personal-imaging repository 106 can be located in various places. For example, the repository 106 can be maintained on one or more computing devices 702, 712, 722, etc. associated with the imaging client 100, imaging source(s) 102, or imaging destination(s) 104. Alternatively, the repository 106 can be maintained on a separate computing device (e.g., a file server) that the imaging client 100, imaging source(s) 102, and imaging destination(s) 104 can access. In this particular arrangement, the data in the imaging repository 106 contains photographs.

Once data is stored in the personal-imaging repository 106, any of the computing devices 702, 712, 722, etc. can be used to select data from the repository 106 that is intended to be communicated to the family web site operative on the server 715. By way of example, the data in the imaging repository 106 may be transmitted to the family web site for displaying images of photographs taken during a family reunion, a wedding, graduation, or other important occasion. In preferred embodiments, the data may include a composition 755 or a set of identifiers identifying both a composition 755 and one or more images (photographs). Where the imaging destination(s) 104 are adapted for displaying photographs, they may comprise any of a wide variety of indexing and identification information, such as information indicative of a preferred display sequence and/or date, time, occasion, and subjects observable in a specific image.

As described above, and further illustrated in the schematic of FIG. 7, both photographs 750 and compositions 755 may traverse the various links 736 and 746 coupling the imaging client 100, the personal-imaging repository 106, the imaging sources 102 and the imaging destinations 104.

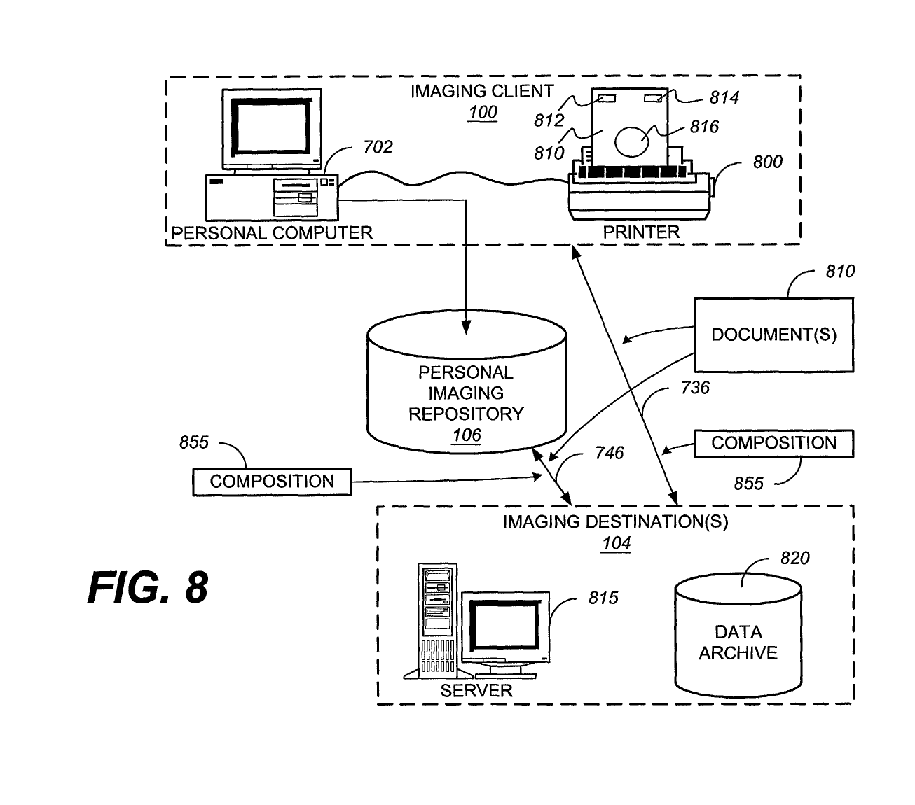

FIG. 8 is a schematic diagram illustrating an exemplar network-based imaging solution that illustrates data flows between the various computing devices and a user's personal-imaging repository 106 where the imaging destinations 104 process images of documents. As illustrated in the figure, an imaging client 100 communicates with one or more imaging destinations 104 and may also communicate with a personal-imaging repository 106. In this particular arrangement, the imaging destination(s) 104 is a document publishing and archiving service represented by server 815 and data archive 820. As described above, the server 815 may contain one or more images of documents 810 belonging to an operator of personal computer 702, among other computing devices not shown for simplicity of illustration. It will be appreciated that a document publishing and archiving service suitable for generating hard-copy products and/or archiving documents 810 may be operated by a party other than the originating user working on the personal computer 702.

The personal-imaging repository 106 provides image-tracking facilities (and may also in some cases provide image-storage facilities) that may be personalized for each of the operators of the imaging-client computing device 702. Note that each user may be provided his or her own personal-imaging repository 106, or alternatively, a personal-imaging repository service may be operable on the imaging client computing device 702. The personal-imaging repository service may be configured to manage imaging-storage tasks, defaults, and personalized image storage, as well as other processing options for each of the multiple users of the imaging-client computing device 702.

As also described above, the personal-imaging repository 106 can be located in various places. For example, the repository 106 can be maintained on one or more computing devices (e.g., personal computer 702) associated with the imaging client 100 or the imaging destination(s) 104. Alternatively, the repository 106 can be maintained on a separate computing device (e.g., a file server) that the imaging client 100 and imaging destination(s) 104 can access. In this particular arrangement, the data in the imaging repository 106 contains documents 810.

The computing devices or devices on which the personal-imaging repository 106 is maintained can change dynamically as imaging data is integrated into or removed from the personal-imaging repository 106. The personal-imaging repository 106, might be thought of as the “web” of imaging information (graphics, compositions) associated with the user. Just as the “world wide web” changes as new web pages are added and old ones are removed, the personal-imaging repository 106 can also change. An important distinction, however, is that the personal-imaging repository 106 is specific to a particular user. This personalization, however, does not preclude the possibility that imaging data will be integrated into more than one user's personal-imaging repository 106.

Once data is stored in the personal-imaging repository 106, the personal computer 702 can be used to direct the generation of a hard-copy product (i.e., a printed page) that includes a number of different images in register with one another along the surface of a page. The personal computer 702 logically interacts with the imaging-destination service providing the printing capability.

In a similar manner, the personal computer 702 can be used to direct the archiving of a document via the personal-imaging repository 106. Select data from the personal-imaging repository 106 that is intended to be communicated to a document archive service operative on the server 815 and the data archive 820 may include a composition 855 that contains information describing the location of a specific version of the letterhead 812, status label 814, watermark 816, as well as body text (not illustrated) of a document of interest 810.

In preferred embodiments, the data may include the composition 855 or a set of identifiers identifying both the composition 855 and one or more documents 810. Where the imaging destination(s) 104 are adapted for publishing and/or archiving documents, they may comprise any of a wide variety of indexing and identification information, such as information indicative of a preferred display arrangement and/or date, time, originator, etc. of the documents 810.

In this way, data in the personal-imaging repository 106 may be transmitted to the document publishing and archiving service for mass production and/or archiving of the document of interest 810. As long as a digital version of each of the component images identified in a composition 855 is available, the document publishing and archiving service can recreate a previously stored document complete with the active-letterhead template in use when the document 810 was created and/or otherwise released or distributed.

As described above, and further illustrated in the schematic of FIG. 8, both documents 810 and compositions 855 may traverse the various links 836 and 846 coupling the imaging client 100, the personal-imaging repository 106, and the imaging destinations 104.

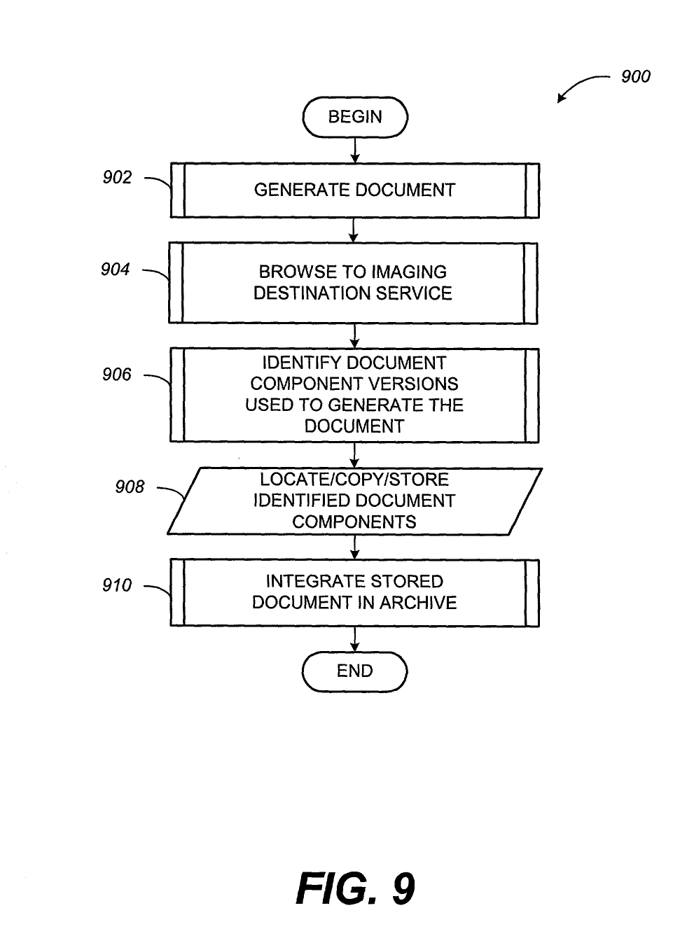

Exemplar systems and methods for transferring imaging information having been described above, a sample method for archiving a document will now be discussed. In this regard, the following discussion describes steps illustrated in the flowchart of FIG. 9. It should be understood that any process steps or blocks in the flowcharts of both FIGS. 6 and 9 may represent modules, segments, or portions of code that include one or more executable instructions for implementing specific-logical functions or steps in the associated process. It should be appreciated that although particular process steps are described, alternative implementations are feasible. Moreover, some method steps may be executed out-of-order from that shown or discussed, including substantially concurrently or in reverse order, depending on the functions involved.

Reference is now directed to FIG. 9, which presents a flowchart illustrating a method for archiving a document 900 that may be used in the network-based imaging system of FIG. 8. In this regard, a user practicing the method 900 may begin by generating and/or otherwise selecting a previously generated document as indicated in step 902. Next, as illustrated in step 904, a user practicing the method 900 may browse and/or otherwise establish a communication link or session with a destination-imaging service, such as the document publishing and archiving service described above with regard to the system of FIG. 8.

After having established a communication link or session with a computing device within the imaging destination 104, the user may be presented with a prompt to identify the document component versions used to generate the identified document as indicated in step 906. As described above, a user of the network-based system can identify the document components by generating and communicating a composition 855 to the imaging destination 104. Once the composition 855 has been generated and communicated to the imaging destination 104, application software, either automatically or under the direction of a user of the system, may be configured to locate, copy, and/or store the composition 855 on data archive 820 or other data-storage devices (e.g., RAM, hard-disk drive, optical-data drive, etc.) as may be desired as illustrated in step 908. Next, as illustrated in step 910, application software operable on one or more computing devices associated with the imaging destination 104 may be configured to generate or otherwise enable a mechanism that permits access to network-connected computing devices to the composition 855.

It should be appreciated that method steps 902 through 910 may be repeated as desired to generate and store a composition 855. Consequently, there is no limit to the number of separate and distinct compositions 855 that may be produced, stored, integrated, and subsequently accessed by computing devices coupled to the system. It should be understood that multiple labels 814, letterheads 812, watermarks 816, and body text may be identified by a composition 855. This flexibility permits a user of the system to identify various arrangements of document components when creating a document.

A letterhead 812 is a humanly observable image containing text and graphics (e.g., a logo), which can be layered upon one or more pages of a letter or other correspondence. Generally, the information within the letterhead 812 contains one or more identifiers commonly associated with the party or organization that generated the correspondence. These identifiers may include the name and address of an organization, as well as the name, office, and contact information of the individual that authored the message in the correspondence along with other information. Typically, the letterhead information is added or layered on top of the first page of a composition (i.e., the target or primary image may be applied after the letterhead 812 has been applied to the physical medium). The same or other letterhead images can be applied to the remaining pages of the document 810 in any other arrangement as may be desired.

A watermark 816 is an image component that contains a visible graphic and/or text based image that identifies the originator and/or the state or nature of the underlying document 810. For example, it is often desirable to mark a document with a company logo or a company name to authenticate the source of the document 810. While it may also be desirable to add electronic or other digital signatures to an electronic version of a document 810 to authenticate its source, a watermark 816 for the purposes of this discussion is an image component.

A label 814 is an image of text that may be added as a separate and distinct component to a document 810 or a composition 855. For example, it is often desirable to add text describing the present state of the underlying information in the document 810 (e.g., “Draft,” “Working Copy,” “Original,” etc.). In addition, it is often desirable to mark documents with a classification level, such as, “Confidential” or “Proprietary.” Document authors often add these and other classifications to their documents 810 for use as a quick reference in identifying a limited group of intended recipients of the underlying message.

In some embodiments, the composition 855 including its component parts may be added and/or otherwise identified as a “preferred” or “default” composition. A “default” composition is a reference to the composition designated to be used by imaging system. In some embodiments, the default composition will reference the last created composition. This composition may contain references to a particular watermark 816, label 814, and perhaps-other images. The default composition solves the problem of identifying which of the available compositions to choose.

Note that automatically selecting the default composition does not preclude selecting another composition. The default composition is simply the composition identified by a value stored in the user's profile. This value contains a reference to the composition designated to be the default composition (by virtue of the value of the default composition reference) and can be located anywhere on the network. Note further that the default composition is not necessarily located in the default-composition store. Because the composition is a conglomeration of multiple images, the user can initiate a data transfer from any node in communication with the personal-imaging repository 106 regardless of whether the communicating device understands documents 810, watermarks 816, labels 814, etc. Moreover, the user can identify a destination service for processing the “default” composition without having to confirm that the destination device is configured with appropriate software and/or firmware to complete the request.

In addition, the content format can be negotiated. The graphic store might have the ability to supply the imaging data in a variety of formats. The composition store, similarly, might have the ability to take the content supplied by the various content stores and make additional modifications to the file format. Finally, the imaging source might have the capacity to accept a variety of formats. For example, this format negotiation can be accomplished by the destination service (which knows what formats it supports) interrogating the source service (i.e., the composition store) for formats that the source service supports, and then choosing what one or the other services identifies as an appropriate format for the data transfer.

It should be emphasized that the above-described embodiments, particularly, any “preferred” embodiments, are merely possible examples of implementations, merely set forth for a clear understanding of the principles of the systems and methods for generating and transferring information. Many variations and modifications may be made to the above-described embodiment(s) of the systems and methods without departing substantially from the principles thereof. These and all other such modifications and variations are intended to be included herein within the scope of this disclosure and the systems and methods for generating and integrating virtual letterhead(s) using network-based imaging techniques as protected and set forth by the following claims.

Thus, having described the systems and methods for transferring imaging information, we claim the following:

1. A method for transferring imaging information, comprising:
accessing a remote-data server;
identifying an accessible composition;
accessing an imaging-destination service; and
communicating the composition to the imaging-destination service.

2. The method of claim 1, wherein identifying an accessible composition comprises using an application operable on the network-connected computing device to preview photographs.

3. The method of claim 1, wherein identifying an accessible composition comprises using an application operable on the network-connected computing device to preview documents.

4. The method of claim 1, further comprising:
storing the composition such that the composition may be accessed by a plurality of imaging services.

5. The method of claim 4, wherein storing the composition comprises saving the composition on network-coupled personal-imaging repository.

6. The method of claim 1, wherein the step of accessing comprises using an imaging extension.

7. A method for adding imaging information to a service, comprising:
receiving a composition;
identifying the location of the component images comprising the composition;
copying the identified component images of the composition; and
storing the component images.

8. The method of claim 7, further comprising:
integrating the composition within the service such that the composition is accessible.

9. The method of claim 7, wherein receiving comprises a document composition.

10. The method of claim 7, wherein receiving comprises a composition containing a photograph.

11. The method of claim 7, wherein receiving a composition comprises using an imaging extension.

12. The method of claim 7, wherein the step of storing the component images comprises retaining web content such that a copy of the web content can be forwarded to a communicatively coupled computing device.

13. A system for transferring imaging information, comprising:
means for selecting an image;
means for associating the selected image with a composition; and
means for communicating the composition to a computing device.

14. The system of claim 13, wherein the means for selecting comprises an imaging-client device.

15. The system of claim 14, wherein the imaging-client device comprises a browser.

16. The system of claim 15, wherein the browser contains web content, the web content comprising information reflective of the composition.

17. The system of claim 16, wherein the information reflective of the composition is extracted from a network-connected imaging-service.

18. The system of claim 13, wherein the means for communicating comprises an imaging extension.

19. The system of claim 18, wherein the imaging extension communicates with a personal-imaging repository.

20. The system of claim 13, wherein the means for associating comprises logic in an imaging extension.

21. A system for transferring image information, comprising:
a server containing imaging-service content, the server coupled to a network, the imaging-service content comprising a composition; and
a computing device coupled to the network, the computing device configured with a browser, wherein the browser is configured to receive the imaging-service content, extract data reflective of the composition, and provide access to the composition.

22. The system of claim 21, wherein the imaging-service content comprises a document.

23. The system of claim 21, wherein the imaging-service content comprises a photograph.

24. The system of claim 21, wherein the imaging-service content comprises a graphic design.

25. The system of claim 24, wherein the graphic design comprises a watermark.

26. The system of claim 24, wherein the graphic design comprises a letterhead.

27. The system of claim 24, wherein the graphic design comprises a label.

28. The system of claim 21, wherein the browser comprises an imaging extension.

29. The system of claim 21, further comprising:
an imaging-destination service communicatively coupled to the network and a service,
wherein the imaging-destination service receives content from the browser.

30. A computer program embodied on a computer-readable medium, the computer program, comprising code configured for:
receiving imaging-service content;
extracting data reflective of a composition; and
storing the composition.

31. The program of claim 30, wherein the code segment configured to store comprises an imaging extension operative with a browser, wherein the imaging extension communicates with a data-storage device.

32. The program of claim 31, wherein the data-storage device comprises a personal-imaging repository.
